(19) United States
(12) Patent Application Publication
(10) Pub. No.: US 2004/0051373 A1
(43) Pub. Date: Mar. 18, 2004

(54) Flexible rim wheel with resilient spokes

(76) Inventor: Boris Tolkachev, Jersey City, NJ (US)

Correspondence Address: Boris Tolkachev, 11 1/2 Nesbitt St., Jersey City, NJ, 07307, US

(21) Appl. No.: 10/245,468

(22) Filed: Sep. 17, 2002

(51) Int. Cl. B60B 1/02

(52) U.S. Cl. 301/55

(57) ABSTRACT

A wheel having a flexible shape rim, a plurality of resilient spokes with both ends mounted on the flexible shape rim, a plurality of hubs disposed in central part of the wheel. The hubs are mounted on an axle that attached to frame of vehicle and rotate independently. Each hub is in touch with one or more of the spokes in a manner that allows spokes motion in relation to the hub. Shifts of the spokes caused by the hubs movements and the rim distortions enforces the rim to change shape from conventional annular to the shapes such as elliptical, oval, and other similar shapes when stationary and while moving. Adjustment of the flexible rim shape caused by sudden impacts while crossing road obstructions reduces collisions of the wheel with the road obstructions, sufficiently decreasing the impact transmitted from the wheel rim to the hubs and the vehicle frame, allowing the hubs and the vehicle frame to continue movement without stress. The wheel assemble disclosed allows incorporating the function of suspension system into wheel. The wheel disclosed provide significant reduce of kinetic energy waste which otherwise occurs in collisions of wheel with the road obstacles due to the wheel body distortion, pneumatic tire distortion, and due to work of vehicle suspension bracket during the shock absorption. Disclosed wheel assemble provide better load distribution, increase traction over a conventional wheel of the same vertical height providing vehicle with off-road capabilities.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION—FIELD OF THE INVENTION

This invention relates to internally suspended shock absorbing wheels with rim, which can change shape from circular to elliptical, oval and similar when stationary, while moving, and during collisions with road obstructions, thereby allowing smooth vehicle movement, providing decrease in motion resistance, comfort, increase in traction, and improving performance of wheel in wide range of road surfaces including off-road and soft soil roads.

### BACKGROUND OF THE INVENTION

A wheel is an ancient device dating back from 3500 to 3000 B.C. There are many types of wheels, but the most used wheel configuration is circular. To prevent distortion of annular wheel rim, wheels usually made as a unitary wheels or with spokes extended outwardly from a hub of wheel to an annular rim. The negative property of a rigid circular rim is that the wheel having rigid rim, if to consider it separately, do not provide comfortable ride over rough uneven surface. Other negative property of the circular wheel is that it is not suitable for ride in off-rod environment such as a soft, sandy, or gravely surface. Many improvements to eliminate excessive inflexibility of the conventional circular wheel have been found.

To provide smooth and comfortable ride such enhancements as a pneumatic tires and a sophisticated vehicle suspensions are widely in use. From the other hand, many attempts to provide internally suspended sprung wheels have been made. Thus, U.S. Pat. No. 1,450,484 to Childs discloses a circular rim in which suspension provided between a hub and a rim connected with resilient spring elements. Another example of this type of wheel U.S. Pat. No. 1,416,078 to Taylor shows. U.S. Pat. No. 1,079,082 to Wells discloses a circular rim in which suspension provided between a hub and a rim connected with a resilient pneumatic elements. U.S. Pat. No. 4,553,577 to Gregg and U.S. Pat. No. 5,125,443 to Schwartzman, as well as Japan Pat. No. 2002029201 to Naoto discloses a circular rim in which suspension provided between a hub and a rim connected with a resilient spokes.

As well as classical wheel having spokes, all mentioned designs have hub and rim interconnected by spokes, by springs or by resilient elements with one end attached to hub and other end attached to rim. While interconnecting elements of wheels mentioned above are extendable or resilient, outer rim designed to be circular and firm. The main reason why self-suspended wheels with extendable hydraulic and pneumatic elements connecting hub and rim are not widely in use is their technical complexity and excessive energy consumption. The reason why wheels with resilient core and firm rim are not widely in use is that when wheel is so configured, it absorbs vertical and horizontal displacement forces poorly. Hence, a vehicle having a frame connected with hubs of such wheels tends to make oscillatory movements and is unstable in motion.

To provide reliable and comfortable ride of conventional wheel over various surfaces a pneumatic tires are widely in use. One of the primary limitations of rigid wheel with tires coupled to rim is that tires are designed for efficient use for travel on particular surface. Thus, tires effective in smooth and hard surface, such as asphalt or concrete became a burden, inefficient, even unstable in uneven, bumpy, soft, sandy and dirt road. Tires for off-road ride have better traction, but they are heavy, noisy, and uncomfortable, with high energy consumption due to high grade of non-resilient tire distortion.

Moreover, conventional wheels normally must be enhanced by suspension elements, which are in use for absorbing unitary wheel movements and vibrations caused by collisions with road obstructions or potholes. Both the collision of the wheel and the shock absorbing in suspension are lead to energy waste. Despite of a centuries-old history of suspension brackets, ideal suspension bracket is not found till now.

It is well known that flexible trucks are used to increase off-road capabilities of vehicles such as tanks and tractors. To combine valuable properties of a circular wheel and a flexible truck, such enhancements as a variable shaped wheels have been found. Thus, pneumatic transport mechanism comprising a closed flexible track supported at internal side by rollers disclosed at U.S. Pat. No. 6,422,576 to Michaeli and Novoplanski. A variable-shape wheel with segmented rim and pneumatic rods connecting rim segments with hub is disclosed in U.S.S.S.R. Pat. No. 1415612 to Anopchenko.

It is well known that an elliptical wheel has increased traction over a conventional wheel of same vertical high. An elliptical wheel with flexible rim and ellipse generating hub disclosed in U.S. Pat. No. 3,459,454 to Liston et. al.

Improvement with excellent features has been found in U.S. Pat. No. 5,492,390 to Kugelmann. It discloses a variable shaped wheel having a hub, a plurality of extendable rods connecting the hub and a shape adaptable rim. Selected shape of the variable wheel in motion is maintained by continual length adjustment of the ram rods under direction of computer processor.

As well as internally suspended wheels mentioned above, elliptical wheels and wheels with changeable shape of rim of all mentioned designs have hub and rim interconnected by spokes, by springs or by resilient elements with one end attached to the hub and other end attached to the rim.

In addition to mechanical complexity, a primary disadvantage of all this prior systems or solutions lies in their extensive energy consumption during movement of vehicle.

### BACKGROUND OF THE INVENTION—OBJECTS AND ADVANTAGES

One object of the present invention is to provide wheels for vehicular travel where shape of a rim of the wheel is altered from annular to elliptical or oval or other similar shapes therefore providing continuing of smooth horizontal movement of the hub and the vehicle frame while the rim collides with obstructions and unevenness of a road surface.

Another object of the present invention is to provide a wheel that incorporates suspension.

Another object of the present invention is to provide a wheel with shock absorbing capabilities.

Another object of the present invention is to provide wheels for vehicular travel where the wheel shape is altered from annular to elliptical or oval or other shapes to ensure large surface contact for control of traction and contact pressure between the wheel and a surface traveled upon.

Another object of the present invention is to provide wheel shape, which will produce an increase in soft soil performance by increasing traction and decreasing motion resistance.

Another object of the present invention is the provision of vehicle wheel, which provide smooth vehicle movement, supplies shock absorption, incorporates function of suspension, increases traction, while providing high degree of mechanical simplicity and light weight.

This invention unites in simple design the shock-absorbing capabilities of the self-suspended wheels with the advantages of the variable shaped wheels, providing significant decrease of kinetic energy waste than prior designs of variable shaped wheels, reducing force of collisions of wheel with road obstacles, incorporating suspension into wheel, improving traction and providing vehicle with off-road capabilities.

These and other objects, features, aspects and advantages of the present inventions will become apparent to those skilled in the art by the following detailed description when considered in relation to the accompanying drawings, disclosed preferred embodiments of the present invention.

### SUMMARY OF THE INVENTION

In accordance with the present invention a wheel comprises a flexible rim portion, a plurality of curved spokes portions having two ends each of which fasten to said rim portion on distance about ¼ lengths of a periphery of a rim portion, and a plurality of hub portions placed at central part of the wheel, where each hub is in contact to at least one of said spokes portions in a manner that allows motion of said spoke portions in relation to said hub portions.

### BRIEF DESCRIPTION OF THE DRAWINGS

FIG. 1 is an elevational view of flexible rim wheel with eight hub portions, thirty two spoke portions and a rim portion in accordance with a first embodiment of the present invention.

FIG. 2 shows schematical view of bicycle vehicle with flexible rim wheels which alterations of shape are caused by a weight of the bicycle and bicyclist and by road unevenness.

FIG. 3 shows that rotational motion of hubs results in rotational motion of the wheel of the present invention.

FIG. 4 shows the wheel of the present invention which rotary movement is caused by rotary movement of roller mechanism mounted so that is in coupling with rim of wheel.

FIGS. 5A-5F reflects changing in geometry of the wheel of the present invention and spokes of wheel when rim of wheel is distorted.

FIG. 6 is an elevational view of flexible rim wheel with eight hub portions, thirty two spoke portions and a rim portion in accordance with a second embodiment of the present invention.

FIG. 6B is a partial cross sectional view of the wheel in accordance with a second embodiment of the present invention illustrated in FIG. 6 as seen along section line 6B-6B of FIG. 6.

FIG. 7 is an elevational view of flexible rim wheel with a eight hub portions, thirty two spoke portions and a rim portion in accordance with a third embodiment of the present invention.

FIG. 7B is a side view of the wheel in accordance with a third embodiment of the present invention illustrated in FIG. 7 as seen in the direction shown by line 7B-7B of FIG. 7.

FIG. 8 is an elevational view of flexible rim wheel with a sixteen hub portions, thirty two spoke portions and a rim portion in accordance with a fourth embodiment of the present invention.

FIG. 8B is a cross-section view of flexible rim wheel in accordance with a fourth embodiment of the present invention illustrated in FIG. 8 as seen along section line 8B-8B of FIG. 8.

FIG. 9 is an elevational and cross-sectional view of flexible rim wheel with an eight hub portions, sixteen spoke portions and a rim portion in accordance with a fifth embodiment of the present invention with the cross-section of hub, having mechanism for rotation of hubs.

FIG. 10 is an elevational view of flexible rim wheel with an four hub portions, sixteen spoke portions and a rim portion in accordance with a sixth embodiment of the present invention.

FIG. 10B is a partial, cross-section view of a first section of the wheel in accordance with a first and sixth embodiments of the present invention illustrated in FIG. 10 as seen along section lines 10B-10B of FIG. 1 and FIG. 10.

FIG. 10C is a partial, cross-section view of a second section of the wheel in accordance with a sixth embodiment of the present invention illustrated in FIG. 10 as seen along section line 10C-10C of FIG. 10.

### DETAILED DESCRIPTION

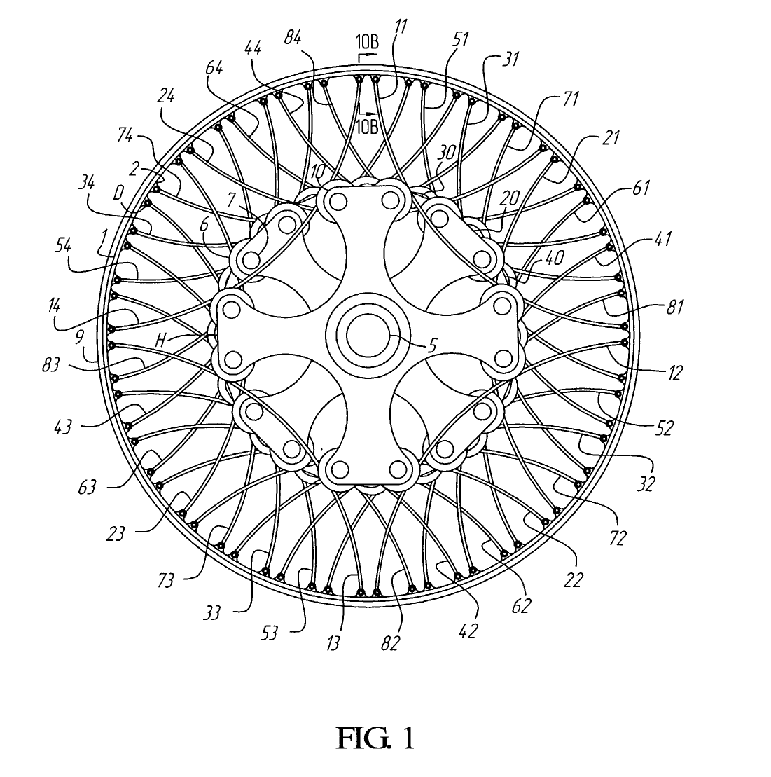

FIG. 1—Preferred Embodiment

Referring initially to FIG. 1, a first embodiment of a wheel in accordance with the present invention is illustrated. Wheel shown in FIG. 1 has a flexible rim portion 1 with a surface engaging material 9, which may consist of rubber or other flexible material bonded to flexible rim portion 1, a thirty two resilient spoke portions 11-14, 21-24, 31-34, 41-44, 51-54, 61-64, 71-74, 81-84, which both ends are attached to the rim portion 1 by means of connectors 2. The spokes are made to be resilient and positioned in a spaced-apart relation to each other. Eight hub portions H numbered 10, 20, 30, 40, 50, 60, 70, 80 adapted to be mounted rotably on an axle 5. Hubs H are positioned in a spaced-apart relation to each other and rotate independently.

The term “flexible rim” as used herein to describe and claim the present invention means a wheel rim which curvature can change both in elastic and in non elastic manner.

The term “spokes” used herein to describe and claim the present invention means spokes that may have constant or variable thickness, with cross-section which is round or distinct from round.

The term “resilient spokes” used herein to describe and claim the present invention means spokes that have a section that can be resiliently bent.

Each of plurality of the spokes has a first end connected to the wheel rim and a second end connected to the wheel rim at distance ¼ of wheel rim periphery length. For the first embodiment of invention according to the present invention illustrated in FIG. 1, length of each of the plurality of spokes is near ¼ of length of the rim periphery.

For the embodiments according to the present invention, shown in FIG. 1 and FIGS. 6-10, the length of the spokes L preferably but not obligatory lays is a range:

$$\frac{P}{π \sqrt{2}} \leq L \leq \frac{P}{π}$$

where P is length of periphery of a rim.

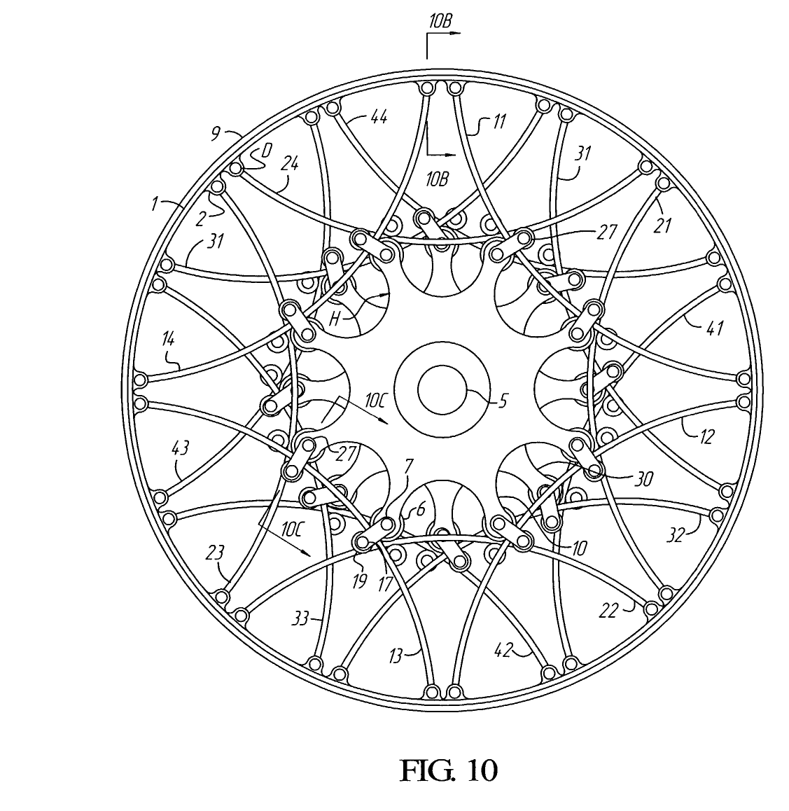

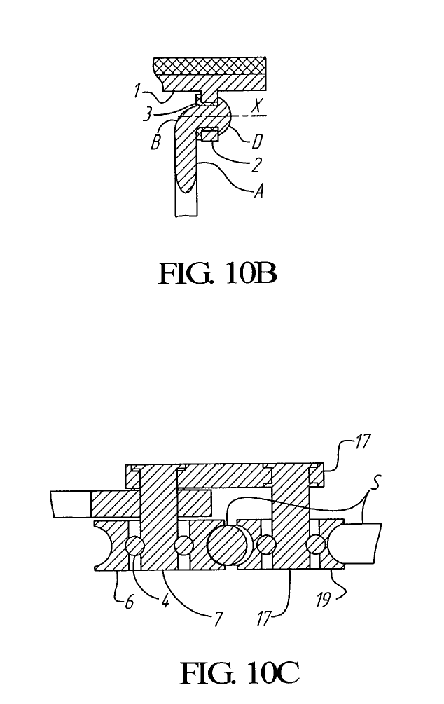

As shown in FIG. 10B, the spokes have a middle section A, and a bent end B with an enlarged head D, such that the middle section A extends at an angle of about 95 degree relative to the bent end B. Such spoke ends are well known in a wheel art. Spokes are mounted to the rim to be able to bend in plane orthogonal to the axis of wheel axle 5 with the spokes ends adapted to rotate around an axis of X of connectors 2. The connectors 2 are rigidly connected to a rim of a wheel. The connectors 2 are supplied with a cartridges 3 ensuring effortless rotation of the spokes around of an axis X of the connectors 2. The middle section of each of the plurality of spokes is curved in the plane which is parallel to a plane of rotation of the wheel. The spokes middle sections are in contact with the hubs H, providing placement of the hubs in the central part of the wheel.

Bearing assemblies rotably support the hub H bodies on the hub axle 5. A bearing assemble basically includes a plurality of balls located between an inner axle race and an outer hub race. Since bearing assemblies is well known in the technical art, they will not be discussed or illustrated in detail herein.

The hubs H have roller portions, with rollers 6 adapted to be mounted rotably on the axles 7 attached to the hubs. Bearing assemblies rotably supports the rollers 6 on the axles 7. Each hub having eight rollers is coplanar and contiguous with four spokes. The axles 7 of the rollers 6 are parallel with the axle 5 of the hubs.

Hubs H are positioned in a spaced-apart relation to each other and rotate independently. The rollers 6 of hub 10 is coplanar and contiguous with the spokes 11-14, the rollers 6 of hub 20 is coplanar and contiguous with the spokes 21-24, the rollers 6 of hub 30 is coplanar and contiguous with the spokes 31-34, the rollers 6 of hub 40 is coplanar and contiguous with the spokes 41-44, the rollers 6 of hub 50 is coplanar and contiguous with the spokes 51-54, the rollers 6 of hub 60 is coplanar and contiguous with the spokes 61-64, the rollers 6 of hub 70 is coplanar and contiguous with the spokes 71-74, the rollers 6 of hub 80 is coplanar and contiguous with the spokes 81-84.

Each roller adapted to be in contact with one spoke, one spoke adapted to be in contact with two rollers both connected to the same hub. Rotation of the rollers 6 allows the spokes to move in relation to the hubs and an axle 5 of the wheel. Deformation of the rim, caused by interaction of the rim with a surface of a road or by any other cause, results in pressure on the spoke ends on the part of the rim, leading to change of curvature of the spokes and to their shift in relation to the hubs, providing in turn, change of the rim shape from circular to elliptical, oval and other similar shapes.

In the illustrated embodiment shown herein, the wheel has flexible rim portion 1, eight hubs H numbered 10, 20, 30, 40, 50, 60, thirty two spoke portions 11-14, 21-24, 31-34, 41-44, 51-54, 61-64, 71-74, 81-84. It will be apparent to those skilled in the art from this disclosure that the embodiment shown can have fewer or more spoke portions and hub portions than illustrated.

It will be also apparent to those skilled in the art from this disclosure that the embodiment shown can have spokes, which both ends are connected with rim on distances different from ¼ lengths of a periphery of a rim.

Of course, it will be apparent to those skilled in the art from this disclosure that pneumatic tire can be mounted on the rim portion 1 instead the surface engaging material 9.

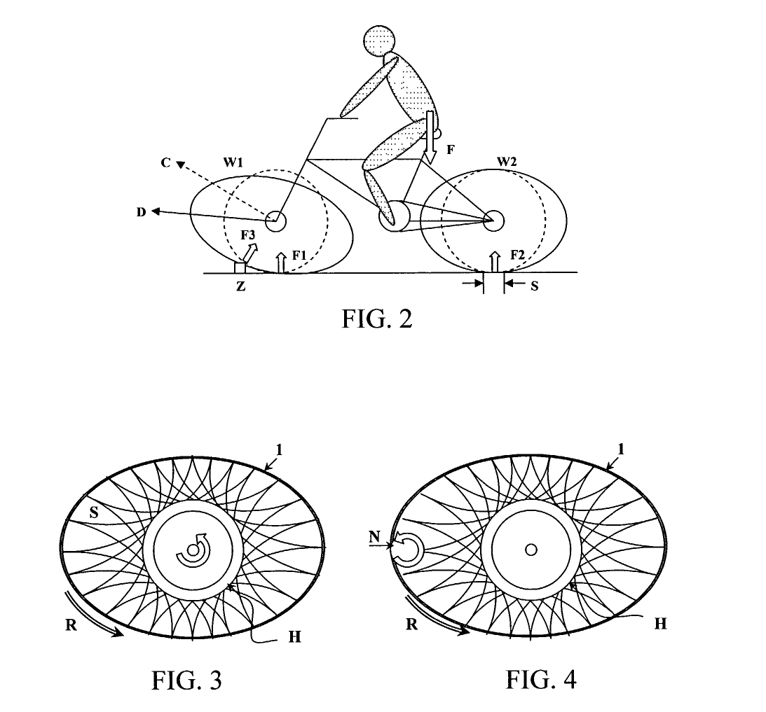

FIGS. 2-5—Explanation FIG. 2 is the schematical image of a bicyclist on a bicycle, which forward wheel W1 and rear wheel W2 are designed in accordance with the present invention. Under action of weight F of a bicycle and bicyclist transmitted on the hubs of the wheels through a frame of a bicycle, there is a changing of the form of the rims of the wheels W1 and W2 caused by interaction of the wheels with a surface of a road. An interaction of a rim with a surface of road designated as F1 for the wheels W1 and F2 for the wheel W2. The wheels change their shape from conventional circular to the shape such as elliptical, oval and similar, resulting in increasing of an area of contact S of each wheel with the surface of the road. The additional influence F3 on the rim of the wheel W1 on the part of roughness of the road, results in greater flattening of the form of the wheel, allowing the axle of the wheel W1, the hubs of the wheel W1, the frame of bicycle and the bicyclist to continue smooth movement in the earlier given direction D while the rim of the wheel W1 undergoes collision with a road obstacle. A direction of movement of conventional circular wheel interacting with the road obstacle Z is designated by dashed arrow C. Of course, it will be apparent to those skilled in the art from this disclosure that vehicles different from bicycle having any number of the wheels designed in accordance with the present invention will have the similar functional properties as bicycle disclosed in FIG. 2

Referring to FIG. 3, the wheel designed in accordance with the present invention is shown. The wheel has set of hubs H, having the annular shape and placed in the central part of the wheel. The shifts of spokes caused by distortion of the form of a rim taking place simultaneously with rotation of a rim results that different hubs rotate around of an axle A with various angular speeds. The rotary movement transmitted on hubs from the outside, for example from the engine of vehicle, taking place in gearing of the hubs H with the spokes S, transfers through spokes S to a rim of the wheel, providing the vehicle movement. The rotation of the hubs in clockwise direction results in rotation of the rim in clockwise direction designated by the arrow R. On the contrary, the rotation of the rim in any given direction, results in rotation of the hubs in the same direction.

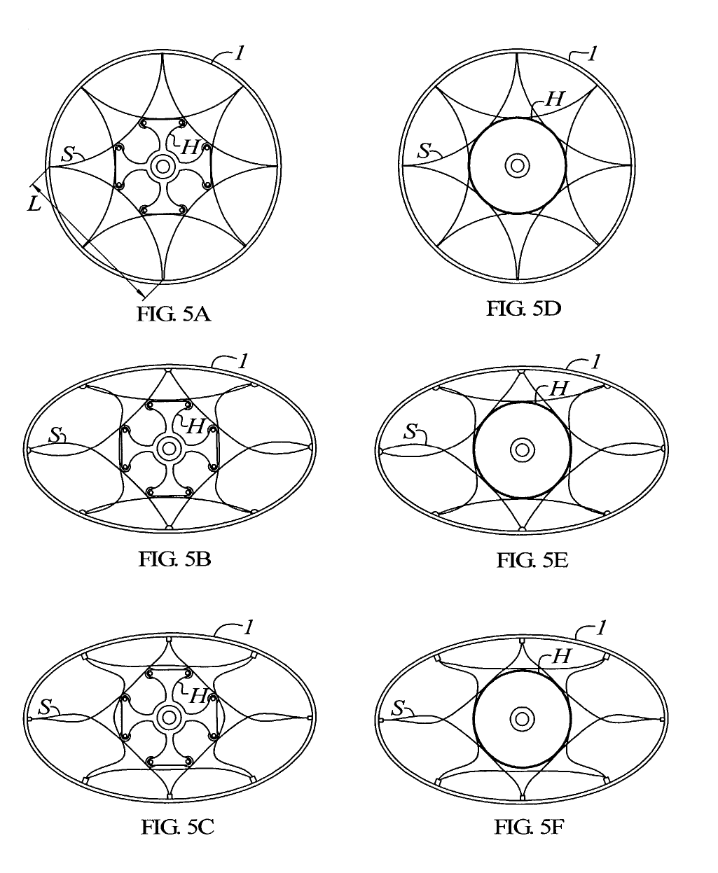

FIG. 4 shows the wheel of the present invention which rotary movement is caused by rotary movement of roller mechanism N mounted so that is in coupling with a rim portion 1 of the wheel. The rotary movement of the roller N which is taking place in gearing with the rim portion 1 of the wheel results in rotation of the wheel, comprising of hubs H, spokes S and rim portion 1 around of an axle A.

Referring to FIGS. 5A-5F, the figures are drawn in comprehension of that fact that lengths of rim and length of spokes of the wheel of the present invention remain constant while distortions. The images of FIGS. 5A-5F reflect change of geometry of the wheel and the portions of the wheel occurring when the wheel rim is distorted.

FIGS. 5A, 5B demonstrate changing of geometry of the wheel and the portions of the wheel wherein the wheel is designed in accordance with the first embodiment of the present invention shown in FIG. 1. FIG. 5A illustrate the wheel with the rim portion which is not distorted. The FIG. 5B illustrates the wheel with distorted rim portion and spokes S.

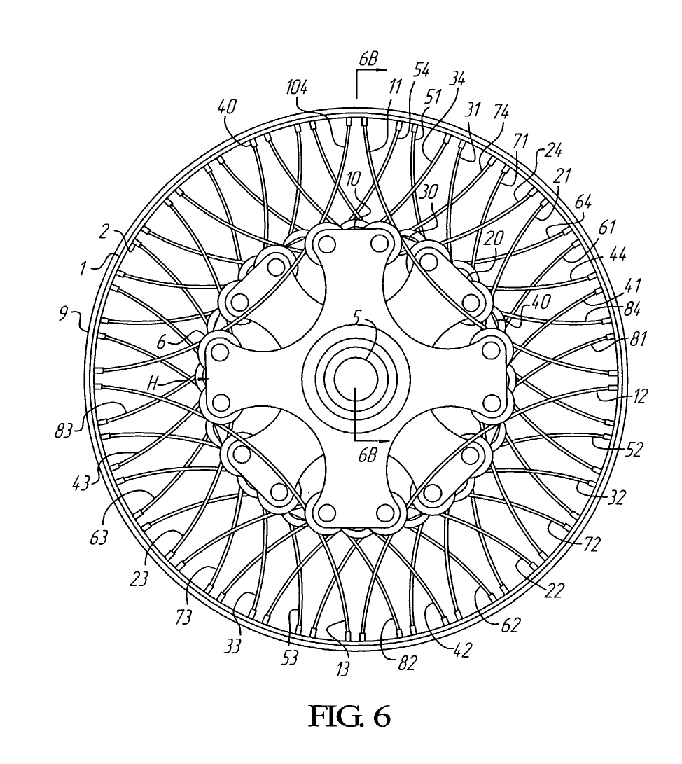

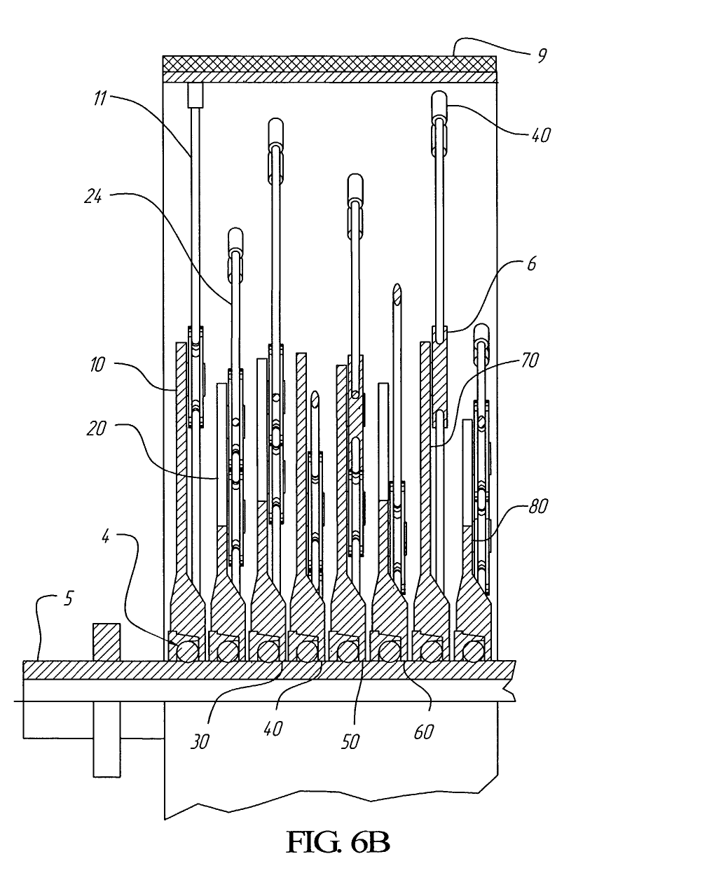

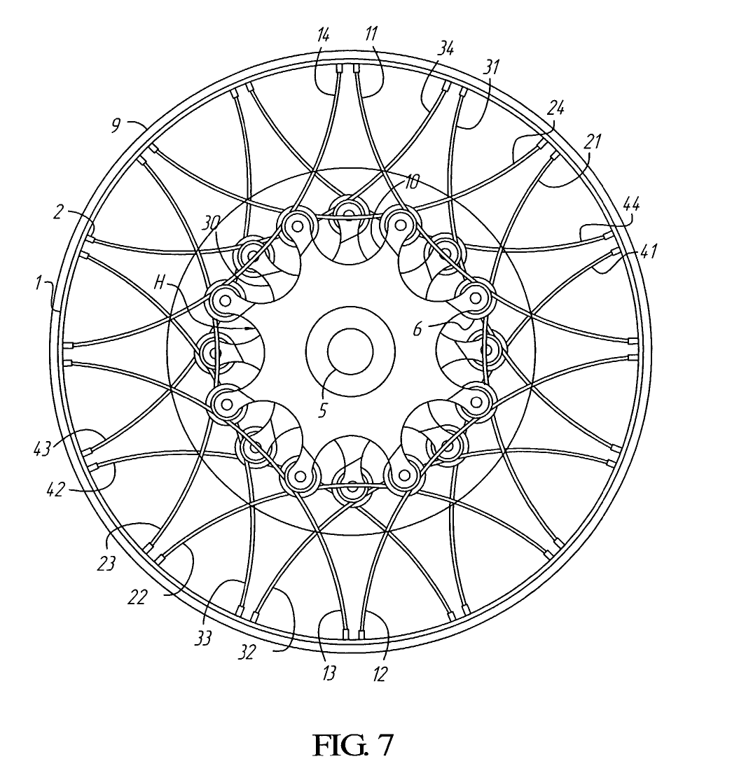

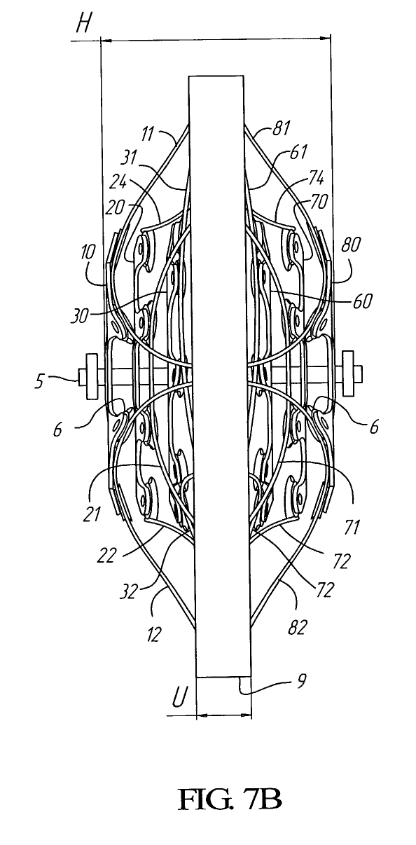

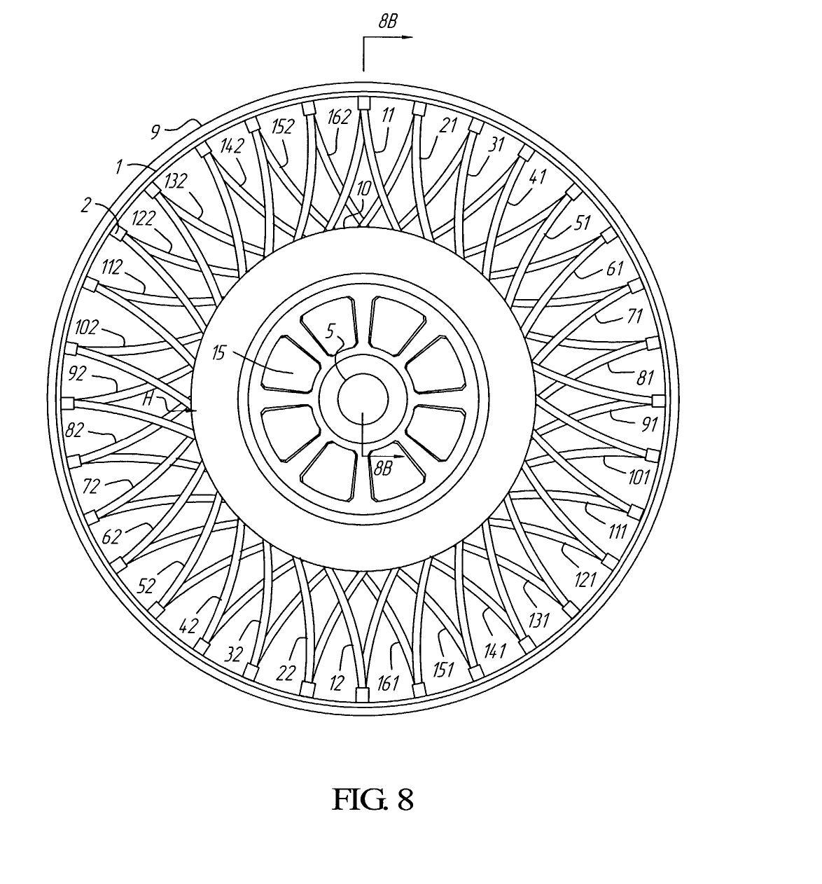

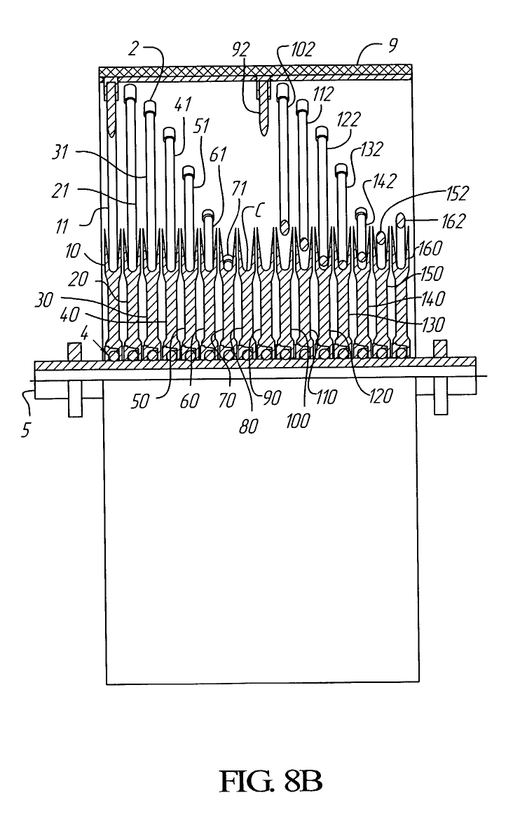

FIG. 5C, demonstrates changing in geometry of the wheel and the portions of the wheel wherein wheel is the wheel designed in accordance with the second and third embodiments of the present invention shown in FIG. 6 and FIG. 7 correspondingly.

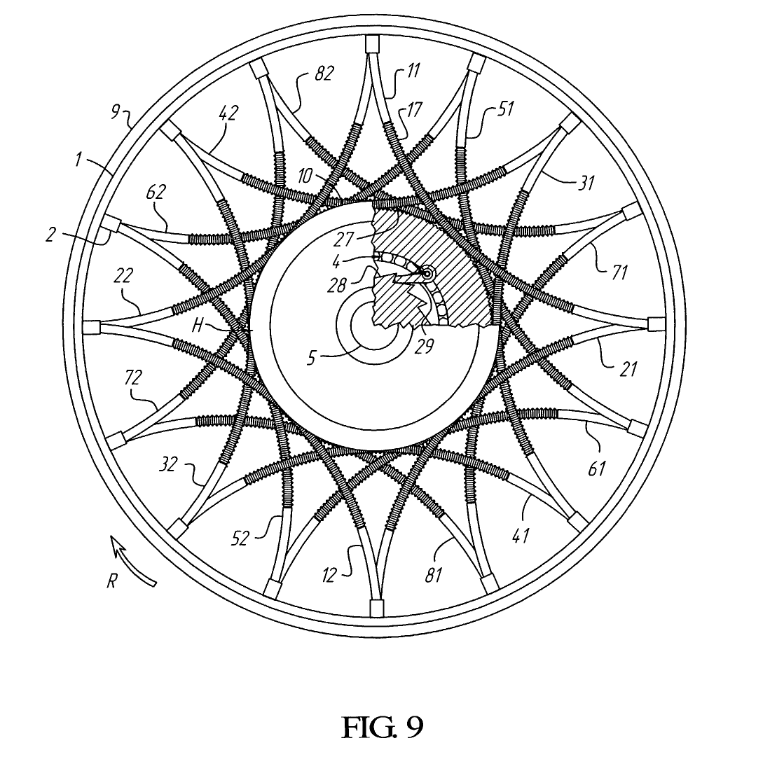

The FIGS. 5D, 5F demonstrate changing in geometry of the wheel and the portions of the wheel wherein the wheel is designed in accordance with the fourth and the fifth embodiments of the present invention shown in FIG. 8 and FIG. 9. FIG. 5D is the rim portion of the wheel is not distorted. FIG. 5D illustrates the wheel with distorted rim portion and spokes S.

The FIG. 5E, reflects changing in geometry of the wheel and the portions of the wheel wherein the wheel designed in accordance with the present invention have a circular hub and the spokes ends fastened on the rim by means of connectors, which allow rotational movement of the spokes ends in a plane which is parallel to the plane of rotation of the wheel.

The images of FIGS. 5A-5f are an illustration of that fact that internal resilience of the wheel designed according to the present invention, provided by change of the spokes shape, which takes place in area between the rim and the hubs H of the wheel. For the embodiments with different geometry of hubs, the spokes are bent differently. The spokes also are bent differently for embodiments with the spokes ends fastened on the rim by means of connectors allowing rotational movement of the spoke ends—FIGS. 5B, 5E, and for embodiments with the connectors rigidly connected with the rim and the ends of the spokes—FIGS. 5C, 5F.

The FIGS. 5A-5F are not reflect any of mentioned embodiments precisely and presented only in order to illustrate that fact, that the internal elasticity of a wheel designed according to the present invention, is provided by plurality of spokes mainly. Of course, it will be apparent to those skilled in the art from this disclosure that a degree of distortion of the rim and the spokes shown in FIGS. 5B, 5C, 5E and 5F is excessive and not that, which will take place at regular conditions of operations of the wheel of the present invention. This extreme distortion is shown only for illustration of the distortion of the rim and the spokes as clear as it needed for the presentation of the wheel of the present invention.

FIGS. 6-10—Additional Embodiments

In the particular second embodiment of the wheel of the present invention, shown in FIG. 6 the wheel embodiment shown in FIG. 1 has been modified. In the second embodiment shown the thirty two spoke portions numbered 11-14, 21-24, 31-34, 41-44, 51-54, 61-64, 71-74, 81-84 are attached to the wheel rim portion by means of connectors 2 that provide bond connection, joining spokes and rim in one portion therefore allowing rim and spokes to be made as a “one-piece” from single continuous material. The rim and the spokes of the present second embodiment shown in FIG. 6 could be produced by die-casting or could be made using composite material as unitary piece if needed or desired.

In the particular third embodiment of the wheel of the present invention, shown in FIG. 7 the wheel embodiment shown in FIG. 6 has been modified. The thirty two spoke portions numbered 11-14, 21-24, 31-34, 41-44, 51-54, 61-64, 71-74, 81-84 are mounted to the wheel rim portion by a manner that allows them to be spaced outwardly from the plane of rotation of the wheel. The deviation of the each set of spokes from the plane of rotation of the wheel is determined by the hub to which spokes assigned to. Thus, the deviations of the spoke set 11-14 are determined and maintained by the rollers 6 of the hub 10, the deviations of the spokes 21-24 are determined and maintained by the rollers 6 of the hub 20. The hubs H numbered 10, 20, 30, 40, 50, 60, 70, 80 are mounted on the axle of the wheel distantly from each other so that the distance between the hub body 10 and the hub body 80 is bigger than the width U of the rim. The third embodiment of the wheel of the present invention shown in FIG. 7 provides the wheel with the narrow rim if needed or desired. Geometry and placement of the hub bodies and of the rollers provide the outward spokes positions that enhance ability of the wheel to withstand horizontal displacements of the rim, therefore enhance vehicle stability in direction orthogonal to the direction of vehicle movement and as a result, improve vehicle performance.

In the particular fourth embodiment of the wheel of the present invention, shown in FIG. 8 the wheel has flexible rim portion 1, thirty two resilient spoke portions numbered 11-12, 21-22, 31-32, 41-42, 51-52, 61-62, 71-72, 81-82, 91-92, 101-102, 111-112, 121-122, 131-132, 161-162 with both ends of spokes mounted on the flexible rim by means of connectors 2, sixteen annular hub portions H numbered 10, 20, 30, 40, 50, 60, 70, 80, 90, 100, 110, 120, 130, 140, 150, 160 adapted to be mounted rotably on the hub axle 5. Hubs H are positioned in a spaced-apart relation to each other and rotate independently. Bearing assemblies 4 rotably supports the hub H bodies on the hub axle 5.

Each hub body is coplanar and contiguous with two spokes. The hub body 10 is coplanar and contiguous with the spokes 11-12, the hub body 20 is coplanar and contiguous with the spokes 21-22, the hub body 30 is coplanar and contiguous with the spokes 31-32, the hub body 40 is coplanar and contiguous with the spokes 41-42, the hub body 50 is coplanar and contiguous with the spokes 51-52, the hub body 60 is coplanar and contiguous with the spokes 61-62, the hub body 70 is coplanar and contiguous with the spokes 71-72, the hub body 80 is coplanar and contiguous with the spokes 81-82, the hub body 90 is coplanar and contiguous with the spokes 91-92, the hub body 100 is coplanar and contiguous with the spokes 101-102, the hub body 110 is coplanar and contiguous with the spokes 111-112, the hub body 120 is coplanar and contiguous with the spokes 121-122, the hub body 130 is coplanar and contiguous with the spokes 131-132, the hub body 140 is coplanar and contiguous with the spokes 141-142, the hub body 150 is coplanar and contiguous with the spokes 151-152, the hub body 160 is coplanar and contiguous with the spokes 161-162. Rotation of the hubs H around axle 5 allows the spokes to move in relation to the hubs H. Deformation of the rim portion leads to change in the shape of each resilient spokes and to shift of the spokes and to rotation of the rotably mounted hubs H around axle 5, thereby providing change of the rim portion shape from circular to elliptical, oval and other similar shapes. As seen in FIG. 8, the weight of hub portions H is reduced by recesses 15.

In the particular fifth embodiment of the wheel of the present invention, shown in FIG. 9 the wheel has a flexible rim portion 1, a sixteen resilient spoke portions numbered 11-12, 21-22, 31-32, 41-42, 51-52, 61-62, 71-72, 81-82 with both ends of spokes mounted on the flexible rim by means of connectors 2, eight annular hub portions H numbered 10, 20, 30, 40, 50, 60, 70, 80 adapted to be mounted rotably on the hub axle 5. The spokes have a gear surface with ledges and hollows. The hubs H have channels C which bottom surface is covered with gear ledges, which size corresponds to the sizes of gear of spokes, therefore the deepenings and ledges of the surface of the hubs H channels C are in gearing with the ledges and deepenings of the spokes. Each hub body is coplanar and contiguous with two spokes. The hub body 10 is coplanar and contiguous with the spokes 11-12, the hub body 20 is coplanar and contiguous with the spokes 21-22, the hub body 30 is coplanar and contiguous with the spokes 31-32, the hub body 40 is coplanar and contiguous with the spokes 41-42, the hub body 50 is coplanar and contiguous with the spokes 51-52, the hub body 60 is coplanar and contiguous with the spokes 61-62, the hub body 70 is coplanar and contiguous with the spokes 71-72, the hub body 80 is coplanar and contiguous with the spokes 81-82.

The gear bottoms of the channels C of the hubs H and gear surface of the spokes provides steady connection of the hubs H with the spokes, eliminating sliding of spokes relating to hubs. The rotary movement of the hubs H results in rotary movement of the spokes which are in gearing with the hubs, and, as a consequence, to rotation of the rim portion of the wheel. The reliable braking is carried out with the help of the same improvement of the hub and the spokes.

Bearing assemblies 4 rotably supporting the hubs H on the axle 5 are in use. Each hub H has a means ensuring coupling of the hub with the axle 5 transmitting rotary movement of the axle 5 to the hubs H. The coupling mechanism having a lock 29 that may come in gearing with ledges 28 of an axle 5 is shown in FIG. 9. Since that coupling assemble of this type is well known in the bicycle art, it will not be discussed or illustrated in detail herein. Of course, it will be apparent to those skilled in the art from this disclosure that many types of coupling assemblies can be used for coupling of hubs and the axle. Bearing assemblies 4 rotably supporting the hub H bodies on the hub axle 5 and the mechanism of coupling of the hubs H and the axle 5 comprising the lock 29 and the ledges 28 provide free rotary movement of the wheel of the present embodiment in a direction clockwise designated by an arrow R.

In the particular sixth embodiment of the wheel of the present invention, shown in FIG. 10, the wheel has a flexible rim portion 1, a sixteen resilient spoke portions numbered 11-14, 21-24, 31-34, 41-44, with both ends of spokes mounted on the flexible rim portion by means of connectors 2, four hub portions H numbered 10, 20, 30, 40 adapted to be mounted rotably on the hub axle 5. Hubs H are positioned in a spaced-apart relation to each other and rotate independently. The hubs H have roller portions, comprising of main rollers 6 adapted to be mounted rotably on the axles 7 attached to the hubs H and a holding rollers 19 adapted to be mounted rotably on an axles 17 attached to a plates 27, which, in turn, are rotably mounted to the axles 7 of the main rollers 6. The axles 7 of the main rollers 6 and the axles 17 of the holding rollers 19 are parallel with the axle 5 of the hubs. The axles 7 are supplied with a cartridges 39 ensuring effortless rotation of the plates 27 around of an axle 7. Bearing assemblies 4 rotably supporting the rollers 6 on the axles 7 and the rollers 19 on the axles 17 are in use.

The rollers 6 and 19 of hub 10 is coplanar and contiguous with the spokes 11-14, the rollers 6 and 19 of hub 20 is coplanar and contiguous with the spokes 21-24, the rollers 6 and 19 of hub 30 is coplanar and contiguous with the spokes 3134, the rollers 6 and 19 of hub 40 is coplanar and contiguous with the spokes 41-44.

Each pair comprising of the main roller 6 and the holding roller 19 is adapted to be in contact with one spoke, and one spoke adapted to be in contact with two pairs of rollers comprising of main roller 6 and holding roller 19 both mounted on same hub H.

The holding mechanism of the sixth embodiment of the present invention, comprising of main and holding rollers ensures steady connection of the hubs with the spokes, eliminating sliding of hubs relating to spokes, providing reliable transmission of rotational motion and the reliable braking.

The same as in wheel of fifth embodiment of the present invention, each hub of the wheel of sixth embodiment of the present invention has a mechanism ensuring coupling of hub with an axle of a wheel transmitting rotary movement of the axle to the hubs. As an example, the coupling mechanism having the lock 29 resting in the ledges 28 of the axle 5 shown in cross-section part of FIG. 9 can be utilized.

The fifth and the sixth embodiment of a wheel shown in FIG. 10 have improvements that provide reliable transferring of a rotary movement or braking from the axle of a wheel to the hubs of the wheel, and further, trough the spokes of wheel to the rim. Most preferable use of first, second, third and fourth embodiments of the present invention shown in FIGS. 1, 6, 7, 8 is their use as conducted wheels of vehicle. Most preferable use of fifth and sixth embodiments of the present invention shown in FIGS. 9, 10 is their use as conducting wheels of vehicle.

It will be apparent to those skilled in the art from this disclosure that the embodiments shown in FIG. 1 and FIGS. 6-10 can have fewer or more spoke portions and hub portions than illustrated.

While only six embodiments have been chosen to illustrate the present invention, it will be readily apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

Advantages

From the description above, a number of advantages of flexible rim wheel described become evident:

The wheel of the present invention lowers the requirements to a suspension bracket and, in many cases, eliminates need in pneumatic tires and suspension brackets.

The spokes of the wheel of the present invention interferes with transfer of road vibrations and impacts from a rim on hubs, allowing placing such fragile devices as electric motors in hubs of wheels.

Use of the wheel of the present invention improves coupling with a surface of a road and allows vehicle to move on loose surfaces.

By manufacture of spokes the various materials with different physical properties can be used. It is preferably to use materials with a high degree of resilience, such, that allow spokes to be repeatedly resiliently bent. It will be apparent to those skilled in the art that for the manufacturing of the wheel disclosed in FIG. 1, and FIGS. 6-10 any suitable material such as steel, titanium, magnesium or composite material can be utilized as needed and/or desired. Thus, use of steel will results in strong high-resilient spokes and rim, use of magnesium spokes and/or rim will enhance shock absorbing and vibrations adsorbing function of the wheel, use of carbon composite materials will results in weight decrease, high resilience and vibration absorption enhancements of spokes and rim.

When the wheel of the present invention rotates, rotation of the main rollers 6 and holding rollers 19, rotation of the hubs H around axle 5, turns of the ends B of the spokes in the connectors 2, bends of the middle parts A of the spokes and distortion of the rim portion constantly and repeatedly take place. All these phenomena have effect of absorption of some amount of energy of a vehicle movement than can be judged as negative. However, these phenomena result in attenuation of oscillatory movements of parts of a wheel, which, otherwise, would have a place persistently. Elimination of oscillatory movements of hubs attached to the frame of the vehicle thus can be provided ensuring incorporation of suspension into wheel of the present invention.

A rim of a classical wheel should be so rigid as far as it possible, therefore weight of a rim always is a significant part of weight of a the wheel. Use of the wheel of the present invention allows reducing of weight of a rim.

I claim:

1. A wheel, comprising:
a flexible rim portion at the outer periphery of the wheel;
a plurality of curved spoke portions having two ends each of which fasten to said rim on distance about ¼ lengths of a periphery of a rim;
a plurality of hub portions pivotably disposed at the centre of the wheel, so that each of said hub portions rotate independently, and each of said hub portions contiguous with at least one of said spoke portions in a manner that allows movement of spoke portions in relation to the hub portions;

2. A wheel according to claim 1, wherein said rim portion deformation is resilient.

3. A wheel according to claim 1, wherein said rim portion deformation is non resilient.

4. A wheel according to claim 1, wherein said rim portion is of constant circumference.

5. A wheel according to claim 1, wherein said spoke portions deformation is resilient.

6. A wheel according to claim 1, wherein outer peripheral surface of said rim portion is coupled with surface engaging material.

7. A wheel according to claim 1, wherein outer peripheral surface of said rim portion is coupled with pneumatic tire.

8. A wheel according to claim 1, wherein ends of said spoke portions are fasten on said rim portion by means of connector portions rigidly connecting said rim portion and ends of said spoke portions.

9. A wheel according to claim 1, wherein ends of said spoke portions are fasten on said rim portion by means of connector portions, which allow rotational movement of ends of said spoke portions in a plane which is parallel to plane of rotation of wheel.

10. A wheel according to claim 1, wherein length of said spoke portions lays in a range
$$\frac{P}{π \sqrt{2}} \leq L \leq \frac{P}{π}$$
where L is length of said spoke portions and P is length of periphery of said rim portion.

11. A wheel according to claim 1, wherein said hub portions are rotably and independently mounted on an axle connected with a frame of vehicle.

12. A wheel according to claim 1, wherein rotational movement of said rim portion is caused by rotational movement of roller portion mounted so that is in gearing with said rim portion.

13. A wheel according to claim 1, wherein braking of said rim portion is caused by braking of roller portion mounted so that is in gearing with said rim portion.

14. A wheel according to claim 1, wherein said hub portions have a means for transferring rotary movement of axle of a wheel to the outer periphery of said hub portions.

15. A wheel according to claim 1, wherein said hub portions have a means for transferring braking from an axle of a wheel to the outer periphery of said hub portions.

16. A wheel according to claim 1, wherein said hub portions have adaptations for inference of said spoke portions in contact with the said hub portions.

17. A wheel according to claim 1, wherein said hub portions have adaptations for eliminating sliding of said spoke portions relating to said hub portions.

18. A wheel according to claim 1, wherein said rim portion, said spoke portions and said hub portions made from materials or have adaptations providing elimination of oscillatory movements of a said rim portion and said hub portions.
